(19) United States
(12) Patent Application Publication
(10) Pub. No.: US 2017/0045224 A1
(43) Pub. Date: Feb. 16, 2017

(54) Damper Safety Switch

(71) Applicant: Sean Scanlon, Sag Harbor, NY (US)

(72) Inventor: Sean Scanlon, Sag Harbor, NY (US)

(21) Appl. No.: 15/236,217

(22) Filed: Aug. 12, 2016

Related U.S. Application Data
(60) Provisional application No. 62/203,962, filed on Aug. 12, 2015.

(51) Int. Cl. F23N 1/00; H01H 36/02; H01H 36/00; F24H 9/20

(52) U.S. Cl. CPC F23N 1/005; F24H 9/2085; H01H 36/02; H01H 36/0013; F23N 2027/02

(57) ABSTRACT

A safety switch that prevents the flow of gas in a gas operated fireplace or furnace when a damper is in a closed position, and only allows the gas flow when the damper is in an open position. The safety switch is mechanically connected to the damper and electrically connected to a gas line valve. When the damper is in an open position, the safety switch allows the gas to flow, or conversely, when the damper is in a closed position, the safety switch prevents the gas from flowing. The safety switch also may provide for audio or visual alerts to indicate the open or closed status of the damper.

### FIELD OF INVENTION

The invention is in the field of chimney and furnace dampers, specifically safety switches for the operation of gas fueled fireplaces and furnaces.

### BACKGROUND

Home fireplaces and furnaces require an exhaust for smoke or fumes created by combustion. The most common exhaust for such smoke or fumes is a chimney or exhaust vent, providing a direct conduit from the fireplace or furnace to the exterior of the building.

To prevent entry of objects from outside of the building, most chimneys and exhaust vents include dampers to close off access to the chimney or exhaust vent. Such dampers may be mounted within the chimney or exhaust vent or as a cap at the end of the chimney or exhaust vent. For home installations, where chimneys are located at or near a roof, the damper is often affixed at the top of the chimney.

When the furnace or fireplace is in operation, smoke and fumes from the combustion need to exit the building through the chimney or exhaust vent, and the damper must be open for the safe operation of the furnace or fireplace. If smoke and fumes remain within the home a health and safety hazard exists. It is known in the field that ensuring that a damper is open is a key safety feature for any chimney.

Fireplaces and furnaces operated using gas instead of wood for combustion present a clean and consistent flame, with less smoke than wood fires. Gas operated fireplaces in homes are desirable for their ease of use. However, there is a significant health risk in having gas flowing openly within a home. Among the dangers are carbon monoxide and gas poisoning, as well as smoke inhalation or fire. To protect against these dangers, regulations for gas operated fireplaces require dampers to be disabled or fixed in an open position.

Open dampers allow external air and objects to enter a house through the chimney, often with undesired effects. For example, because chimneys are located near the roof of a home, small animals may enter the home through the open damper and chimney.

Therefore, a safe solution is needed to allow a damper to be closed when a gas operated fireplace or furnace is inactive, and conversely, to prevent the operation of a gas operated fireplace or furnace when the damper is closed.

### SUMMARY OF THE INVENTION

The present invention is a safety switch that prevents the flow of gas in a gas operated fireplace when a damper is in a closed position, and only allows the gas flow when the damper is in an open position. The safety switch is mechanically connected to the damper and electrically connected to a gas line valve. When the damper is in an open position, the safety switch allows the gas to flow, or conversely, when the damper is in a closed position, the safety switch prevents the gas from flowing.

### BRIEF DESCRIPTION OF THE DRAWINGS

FIG. 1 shows a chimney damper in the open position, with a preferred embodiment of the present invention in a cut away view in the activate position.

FIG. 2 shows a chimney damper in the closed position, with a preferred embodiment of the present invention in a cut away view in the deactivate position.

FIG. 3 shows a cross section view of the present invention in the deactivate position.

FIG. 4 shows a cross section view of the present invention in the activate position.

FIG. 5 shows a cross section view of an alternate embodiment of the present invention in the deactivate position.

FIG. 6 is a block diagram of the present invention.

The attached photographs show the invention with a chain connecting to the damper and wires which lead to the gas line valve.
100 Chimney
110 Damper
120 Damper hinge
80 Damper operating cable
70 Cable clamp
40 Damper handle pull chain
50 Damper handle bracket
55 Damper handle
60 Activating magnet
200 switch
325 electrical leads (from switch)
310 switch contact
320 Magnetic activated switch
280 switch housing
400 channel (in switch housing 280)
500 valve
510 gas line to burner
520 gas line from supply
550 burner/fireplace
570 gas supply

### DETAILED DESCRIPTION OF THE PREFERRED EMBODIMENT

The invention preferably consists of a switch 200 connected to a gas line valve 500 or other control mechanism for controlling the flow of gas or fuel to a fireplace or furnace. The switch 200 is activated by a mechanical connection to damper 110, preferably through the movement of the mechanical connection.

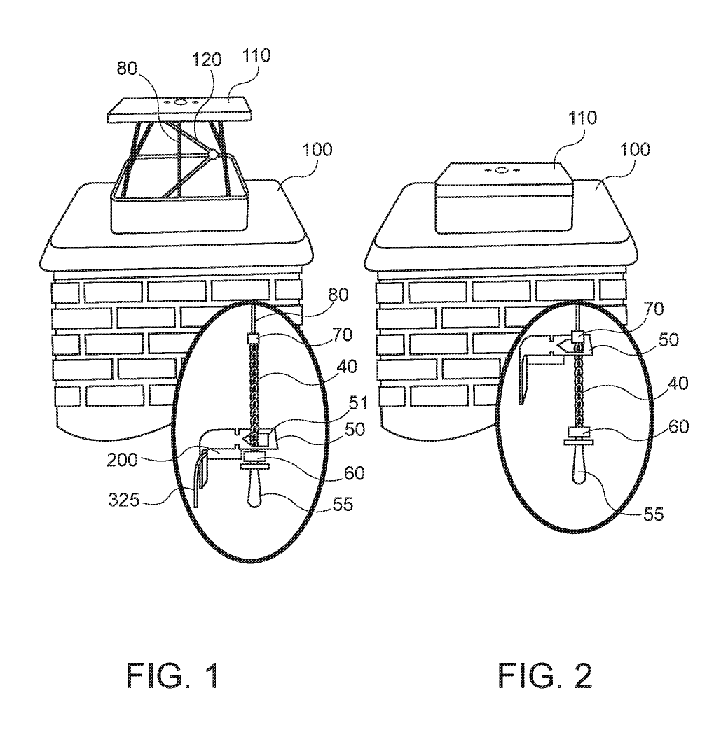

FIGS. 1 and 2 show a conventional chimney and damper assembly, and the conventional chimney and damper assembly is described herein for reference. In FIG. 1, chimney 100 is shown with damper 110 in the open position. Damper 110, as known in the art, may be biased to the open position by damper mechanism 120. Damper operating cable 80 is connected to damper 110 and extends downward through chimney 100. Cable clamp 70 is attached to a lower end of damper operating cable 80, and may have a damper handle pull chain 40 attached below cable clamp 70. Damper handle 55 is attached to damper handle pull chain 40. Damper handle pull chain 40 usually extends through aperture 51 of damper handle bracket 50. In FIG. 2, damper 110 is shown in the closed position, where cable clamp 70 engages aperture 51 to keep damper 110 in the closed position.

In FIGS. 1 and 2, switch 200 is shown mounted on damper handle bracket 50 near aperture 51. Activating magnet 60 is attached to damper handle pull chain 40, preferably near damper handle 55. In FIG. 1, activating magnet 60 is located near switch 200 to activate the switch as discussed below. In FIG. 2, activating magnet 60 is located away from switch 200, leaving switch 200 in a deactivate position.

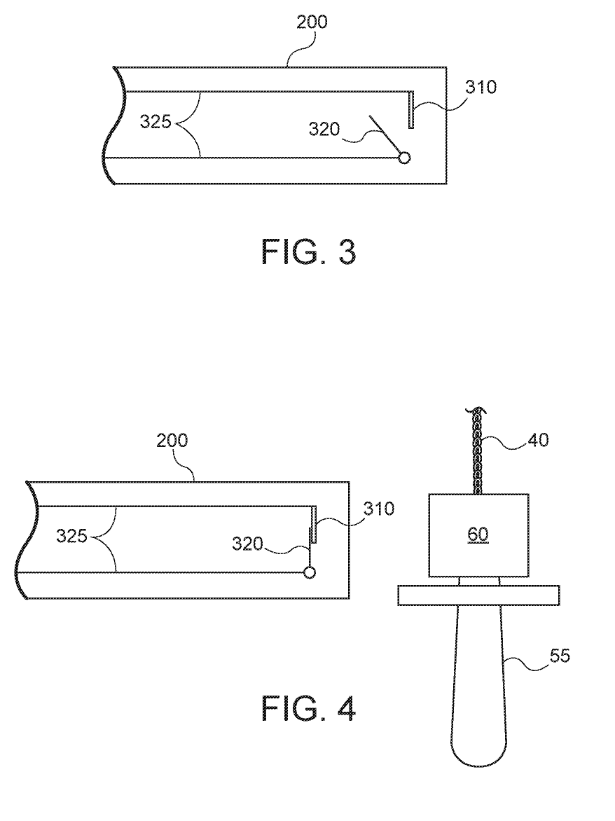

As shown in FIGS. 3 and 4, switch 200 is preferably a magnetic switch, where the movement of activating magnet 60 opens or closes the electrical circuit. In particular, switch 200 preferably includes a switch contact 310 and a movable magnetic switch element 320. Preferably when activating magnet 60 is close to switch 200, as shown in FIG. 4, the magnetic field attracts movable magnetic switch element 320 into contact with switch contact 310 to form a completed electrical circuit. In an alternate embodiment, magnetic switch element 320 may default to contact with switch contact 310 and moving activating magnet 60 near switch 200 causes magnetic switch element 320 to move away from switch contact 310.

Switch 200 may be a magnetic reed switch, as is known in the art.

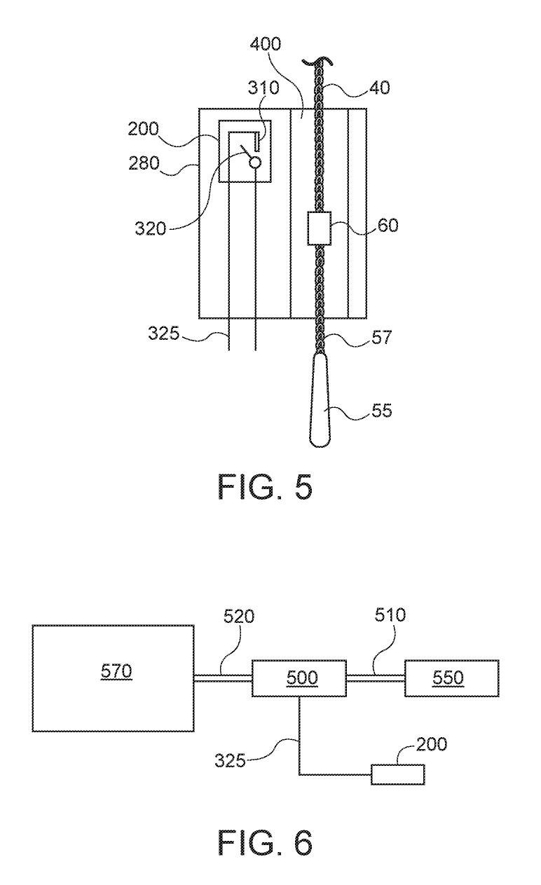

FIG. 5 shows an alternate embodiment of the present invention. Switch 200 is located within switch housing 280. Switch housing 280 includes channel 400 and damper handle pull chain 40 extends there through. Activating magnet 60, attached to damper handle pull chain 40, is capable of movement through channel 400, and when located near switch 200, activates movable magnetic switch element 320 as discussed above.

Electrical leads 325 extend from switch 200 to gas valve 500, as shown in FIG. 5. Gas valve 500 controls the flow of gas from gas supply 570 to combustion device 550, and is operated by an electrical circuit that opens or closes gas valve 500. Gas line 520 extends from gas supply 570 to gas valve 500. Gas line 510 extends from gas valve 500 to combustion device 550. Combustion device 550 may be a gas furnace or gas fireplace as is known in the art.

When activating magnet 60 causes magnetic switch element 320 to move to an activating position with respect to switch contact 310, an electrical signal is sent through electrical leads 325 to gas valve 500. Gas valve 500 then opens to allow a flow of gas between gas supply 570 and combustion device 550. In a preferred embodiment, activating magnet 60 is proximate to magnetic switch element 320 and the magnetic field forces magnetic switch element 320 into contact with switch contact 310 for a closed electrical circuit with gas valve 500. In this preferred embodiment, activating magnet 60 is only proximate to magnetic switch element 320 when damper 110 is in an open position.

Activating magnet 60 is preferably part of or attached to an elongated drive mechanism that directs the opening and closing of the chimney damper. The elongated drive mechanism may be a chain, cable or rod, moving in a bilateral manner within or along the chimney as is known in the art. Preferably, activating magnet 60 may be attached to an existing damper control system.

Existing damper control systems are often chains that extend from the damper down into a fireplace, as shown in FIG. 1. The present invention is intended to be added to such existing damper control systems with minimal installation effort.

The movement of the mechanical connection to the damper also serves to activate switch 200, opening or closing the switch 200, thereby completing the electrical circuit connected to the gas line valve 500.

Where switch 200 is placed within the chimney, switch 200 is preferably made of a thermal resistant material to prevent damage due to heat from the fireplace in use.

Switch 200 may also activate a light, sound, indicator or alarm, advising of the position of the damper 110 and whether it is safe to use the fireplace.

While the preferred embodiment depicts implementation of the invention in a home fireplace and chimney, the invention may also be used with a gas furnace in a home or commercial building.

While certain novel features of the present invention have been shown and described, it will be understood that various omissions, substitutions and changes in the forms and details of the device illustrated and in its operation can be made by those skilled in the art without departing from the spirit of the invention.

I claim:

1. A switch for controlling a gas line valve, the gas line controlling the flow of gas to a combustion device, the switch comprising:
a magnetically activated electrical switch, with electrical connections to the gas line valve; and
a magnet capable of movement between a position proximate to the magnetically activated electrical switch and a position distal from the magnetically activated electrical switch, the magnet's movement mechanically connected to the physical position of an exhaust damper,
where the magnet's position relative to the magnetically activated electrical switch opens or closes an electrical circuit between the magnetically activated electrical switch and the gas line valve.

2. The switch of claim 1, further comprising:
an elongated connector, with a first end connected to the exhaust damper and a second end connected to the magnet, where the exhaust damper is capable of movement between an open position and a closed position, and where the elongated connector moves the magnet between an activated position and a deactivated position, corresponding to the position of the exhaust damper.

3. The switch of claim 1, further comprising:
an alarm device, electrically connected to the magnetically activated electrical switch.

4. The switch of claim 1, where the magnetically activated electrical switch is a magnetic reed switch.

5. The switch of claim 1, where the combustion device is a gas fireplace.

6. The switch of claim 1, where the combustion device is a gas furnace.

7. A safety switch for controlling a gas line valve, the gas line valve controlling the flow of gas between a gas supply and a fireplace, the safety switch comprising:
a magnetically activated electrical switch, with electrical connections to the gas line valve, the magnetically activated electrical switch being activated by an external magnet; and
the external magnet capable of movement between a position proximate to the magnetically activated electrical switch and a position distal from the magnetically activated electrical switch, the external magnet's movement mechanically connected to the physical position of an exhaust damper of the fireplace,
where the external magnet's position relative to the magnetically activated electrical switch opens or closes an electrical circuit between the magnetically activated electrical switch and the gas line valve, and where the electrical circuit causes the gas line valve to control the flow of gas to the fireplace.

8. A safety switch for controlling a gas line valve, the gas line valve controlling a flow of gas to a gas fireplace, the gas fire place connected to a chimney with a damper, the damper capable of being in an open position and a closed position, where the position of the damper is controlled by mechanical means, the safety switch comprising:
an activating magnet attached to the mechanical means controlling the position of the damper, where the activating magnet moves between a first position and a second position, and where the first position correlates with the damper being in the open position and the second position correlates with the damper being in the closed position;
an electric circuit electrically connected to the gas line valve, the gas line valve being located remote from the fireplace, and a portion of the electric circuit extending proximate to the fireplace;
a magnetically activated switch electrically connected to the electric circuit, the magnetically activated switch located proximate to the fireplace, the magnetically activated electrical switch capable of being activated by the activating magnet, where when the activating magnet is in the first position, the magnetically activated switch completes the electric circuit to open the gas line valve, allowing gas to flow to the fireplace.
